(19) United States
(12) Patent Application Publication
(10) Pub. No.: US 2005/0062606 A1
(43) Pub. Date: Mar. 24, 2005

(54) Arrangement and method for detecting unauthorized removal of electronic equipment

(76) Inventor: Ernst Konecnik, Nacka (SE)

Correspondence Address: FASTH LAW OFFICES, 629 E. BOCA RATON ROAD, PHOENIX, AZ, 85022, US

(21) Appl. No.: 10/924,059

(22) Filed: Aug. 23, 2004

Related U.S. Application Data
(63) Continuation-in-part of application No. 10/659,151, filed on Sep. 10, 2003.

(51) Int. Cl. G08B 13/12

(52) U.S. Cl. 340/568.3

(57) ABSTRACT

The arrangement and a method for detecting unauthorized removal of electronic equipment. The arrangement has a power inlet and a power outlet. The power inlet is electrically connected to a power source. The power outlet is electrically connected to an electronic device via a first conducting element. The arrangement has a processor electrically connected to the electronic device via a second conducting element. The processor is adapted to transmit a control signal via the first conducting element to the electronic device that is returned via the second conducting element to the processor. The processor triggers an alarm signal when the control signal is not returned.

### PRIOR APPLICATION

This is a continuation-in-part application of U.S. patent application Ser. No. 10/659,151 filed 10 Sep. 2003.

### TECHNICAL FIELD

The present invention relates to an arrangement and a method for detecting unauthorized removal of an electronic device that is connected to a power source. The arrangement is arranged between the power source and the electronic device.

### BACKGROUND OF THE INVENTION

Today's stores and public premises use more and more audio-visual means for conveying their messages. The audio-visual means may for example be plasma screens and large picture projectors. A problem is that this type of products is very desirable to steal since they are valuable and can easily be sold to receivers of stolen goods. The spontaneous stealing of screens and similar products in public premises is a growing problem. For example, nobody notices if a false service technician removes a projector in a public area and walks away with the projector.

There are many different alarm systems that prevent this type of theft. A common system is a cable, or another signal equipment, that is pulled through the equipment to be protected. An existing opening, such as at a fan, is often used where it is possible to insert the cable and pull out the cable to create a loop that triggers an alarm when cut. This type of alarm system has many drawbacks such as the loop may be attached to, for example, a plastic piece that may be broken or cut so that the equipment may be removed without cutting the loop and the alarm is not triggered. Further, this type of alarm may be by-passed by a conductor that takes over the function of the loop when the loop is cut so that the system senses the intact loop and the alarm is not triggered.

Other alarm systems exist such a metal plates that senses that the contact of the equipment is still connected to the wall or special devices that are mounted in the equipment to be protected.

Some systems sense the current that is delivered to the protected equipment and sends an alarm when this current is too low. One problem with these systems is that they do not function in case of a power outage.

### SUMMARY OF THE INVENTION

The present invention relates to an arrangement and a method for detecting unauthorized removal of electronic equipment that solves the above-mentioned problems. The arrangement is arranged between a power source and the electronic equipment and includes a first current recognizing element. The detection of unauthorized removal is obtained by sensing a level of the current that flows to the electronic equipment. The arrangement of the present invention further sends a signal to the electronic equipment so that the signal is adapted to bounce back to the arrangement. The detection of unauthorized removal is obtained when the following conditions are met; the current sensed is lower than a predetermined value and the bounced back signal is absent. In this way, the advantage is obtained that the alarm will not be triggered in case of a power outage, when the current is thus zero, as long as the apparatus is connected and the bounced signal can be detected.

In a preferred embodiment, the arrangement has an alarm unit arranged to send an alarm signal to an alarm center when the detection of unauthorized removal is obtained.

In a further embodiment, the arrangement includes a second current recognizing element that senses the current delivered from the power source. In this embodiment, the bouncing signal is sent to the electronic equipment when the current sensed by a second current recognizing element is lower than a predetermined value.

In a preferred embodiment, the arrangement includes a unit that sends a signal to the electronic equipment. In case of power outage, the unit is transferred to operate via the batteries. In this way, the removal of the protected equipment is detected even during a power outage. The batteries are dimensioned to handle continuous operation for 24 h and the alarm for at least 5 h when there is a power outage. The lifetime of the batteries is about 5-6 years. When the battery level is reduced below a level, this is indicated so that the batteries can be replaced. During continuous normal operation the batteries are charged.

In a preferred embodiment, the arrangement further includes a unit that is connected to the audio-contact of the electronic equipment. The unit is arranged to sense a resistance that has a predetermined value and a signal is sent to an alarm unit when the resistance is different from this value.

In yet a preferred embodiment, the arrangement has a power inlet and a power outlet. The power inlet is electrically connected to a power source. The power outlet is electrically connected to an electronic device via a first conducting element. The arrangement has a processor electrically connected to the electronic device via a second conducting element. The processor is adapted to transmit a control signal via the first conducting element to the electronic device that is returned via the second conducting element to the processor. The processor triggers an alarm signal when the control signal is not returned.

### BRIEF DESCRIPTION OF THE DRAWING

FIG. 1 is a schematic view of a preferred embodiment of the present invention; and

FIG. 2 is a schematic view of an alternative preferred embodiment of the present invention.

### DETAILED DESCRIPTION

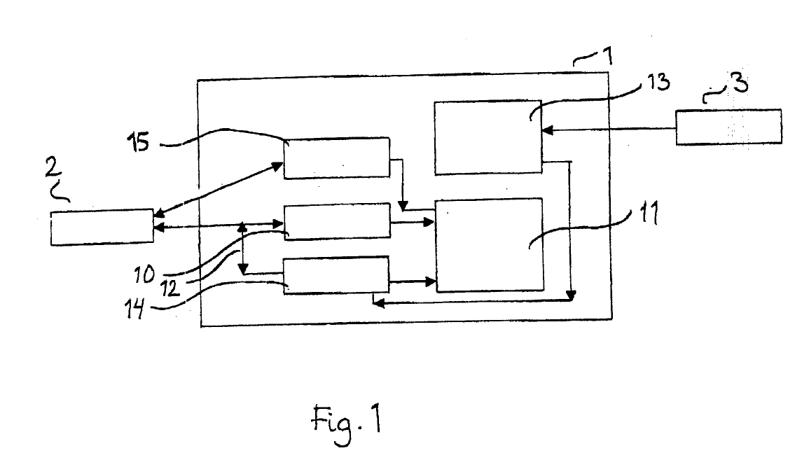

FIG. 1 shows a block diagram of a preferred embodiment of the arrangement of the present invention. The arrangement 1 is connected between the item that needs to be protected, such as electronic equipment 2, and a power source 3. The arrangement includes a first current recognizing element 10 that senses a current in a wire 20 that is delivered to the equipment 2. When the first current recognizing element 10 indicates that the level of current flowing in the wire 20 towards the equipment 2 is lower than a predetermined value, that varies depending upon which equipment that is to be protected, a signal is sent to an alarm unit 11. The alarm unit 11 is connected to an alarm center. When the alarm unit 11 alarms a signal is sent to the alarm center. The arrangement 1 also includes a second current recognizing element 13 that senses the current that is delivered from the power source 3. When the second current recognizing element 13 indicates that the current is too low, a signal is triggered to the unit 14 that goes into a so called loop mode and sends a signal 12 at a predefined frequency to the equipment 2. This signal bounces back to the unit 14 when the protected equipment 2 is in place and properly connected to the arrangement 1. In the case when the equipment 2 has been removed from its place, the signal sent by the unit 14 will not bounce back and the unit 14 sends a signal to the alarm unit 11 that sends out an alarm. The unit 14 is equipped with batteries for ensuring it functions during power outages.

The arrangement 1 also includes a sensing unit 15 that is connected to an audio-contact of the equipment 2. The unit 15 senses a resistance 75 Ohm and sends a signal to the alarm unit 11 when the resistance sensed is different from this value or any other predetermined resistance value.

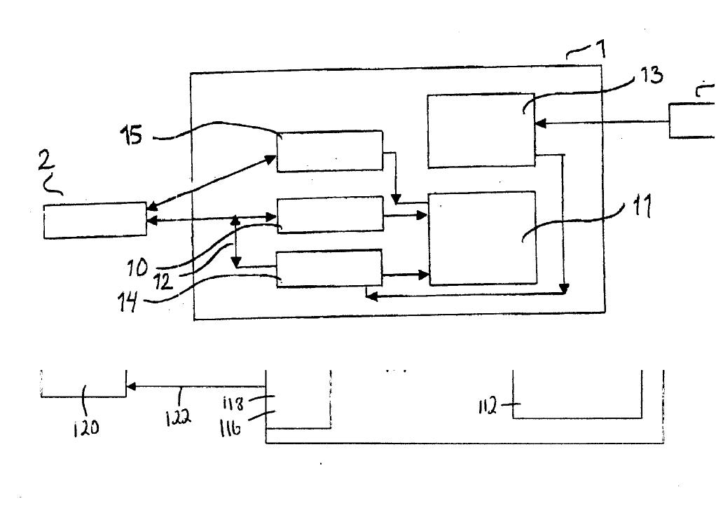

FIG. 2 is an arrangement 100 that has a power input 102 connected to a power cord 104 including a ground 105. The arrangement 100 may have a battery backup unit 106, an alarm unit 108, a keypad 110 to turn on and off the arrangement and a telecommunication module 112 that may be used for connecting the arrangement 100 to a mobile GSM telephone or any other suitable communication device. The arrangement permits current to flow therethrough without affecting or distorting the current. The arrangement 100 also has a processor 114 for generating signals and a power output 116 including a ground 118. The output 116 may be connected to an electrical/electronic unit 120 such as a computer via a cord 122. The processor 114 may be connected to a unit 124 via a wire 126 that extends through the unit 124 and is attached to a housing of the electronic unit 120. The unit 124 may have a diode 125 to indicate that the alarm has been turned on. It is also possible to remove the diode and replace it with a conventional resistance device. The diode is preferred since it indicates that the alarm is on. If the diode is not on then either one of the wires or cords have been cut or the diode has been bypassed. In other words, the alarm is also triggered when the system senses that the resistance from the diode 125 is missing or different from a preset value.

The alarm may be activated by using the keypad 110 or by sending an activation message to the telecommunication module 112. This message may include an activation code. The electronic unit 120 may be used in any conventional way, such as turning on and off the unit 120, without triggering the alarm. However, the disconnection of the power cord 122 or the wire 126 triggers the alarm. If the power cord 104 is pulled, the backup battery provides the power. It is not possible to connect the unit 124 and the power output 116 or the processor 114 in order to prevent the activation of the alarm.

The processor 114 may continuously send a signal 132, such encrypted digital signals that are generated at random so that each signal is different, via the ground 118 of the cord 122 and then through the unit 124 so that the diode indicates that the alarm is on by being lit. The signal 132 continues into the housing (ground) of the electronic unit 120 and is returned back to the processor via the cord 122 of the power output 116. Preferably, the signal 132 is sent via the ground conduction of the wire 126, the housing of the electronic unit 120 and the ground conduction of the cord 122. It is also possible to send the signal 132 in through the cord 122 and out through the wire 126. If the signal 132 is returned to the processor 114 without distortion no alarm is triggered. If the signal 132 is not returned to the processor 114, the alarm is triggered. This may happened if either the cords 104, 122, 124 are somehow disconnected or the cords 122, 124 distort the signal 132. The alarm may also be triggered if the current is distorted. Preferably the incoming current is not associated with the signal 132. It is possible to use a connection device that may be set to send an alarm when the incoming current to the unit via the cord 104 is missing. The processor 114 may continuously send the signal 132 to the unit 120 without having to wait for a reduction of the voltage potential. The present invention may also be used for electrified fencing and barbed wires. An alarm is triggered as soon as the wire is cut and it can be determined where on the wire the cut is located. It is also possible to use the system of the present invention in metal doors and lead the current through the door so that the alarm is triggered when the door is opened and the circuit is broken. In this way, there are no visible sensors that may be bypassed by intruders. The signal 132 may be digital and frequently changed by using a random generator so that it is impossible to duplicate the signal even though it may be possible to read the signal.

The arrangement may also have a sensor that senses the potential and the current to indicate when it is time to replace the backup batteries. It may also put a load on the batteries to check on the condition of the battery. It may have a tampering protection so that an alarm is triggered if somebody is repeatedly entering the incorrect codes on the keypad. The system may have four wires/cables to sense which button or key that has been activated to take advantage of the fact that the processor senses which button/key in the matrix that has been activated. This means that the key activation cannot be copied or intercepted and the keypad cannot be bypassed since the activation is digital and does not include seven wires, as in conventional systems, that make it possible to short-circuit, bypassed and intercepted. The arrangement may be equipped with sensors that sense the position of the arrangement and trigger the alarm if the position is different. For example, the unit may, during the start up, sense if the unit is mounted in a horizontal, vertical position or at a sloping position. When the unit is moved from this position, the alarm may be triggered. To reset the alarm and change the preset position of the unit, the entire system must be reset otherwise the alarm is triggered unless the unit is positioned in exactly the preset position. Rapid movements may trigger the alarm signal also.

While the present invention has been described in accordance with preferred compositions and embodiments, it is to be understood that certain substitutions and alterations may be made thereto without departing from the spirit and scope of the following claims.

1. An arrangement for detection of removal of electronic equipment, comprising:
the arrangement having a power inlet and a power outlet, the power inlet being electrically connected to a power source, the power outlet being electrically connected to a ground of an electronic device via a first conducting element;
the arrangement having a processor electrically connected to a ground of the electronic device via a second conducting element, the processor being adapted to transmit a control signal via the first conducting element to the electronic device that is returned via the second conducting element to the processor, the processor triggering an alarm signal of an alarm when the control signal is not returned; and
a diode electrically connected to the second conducting member.

2. The arrangement according to claim 1 wherein the diode is on when the alarm is turned on.

3. The arrangement according to claim 1 wherein the diode is adapted to trigger the alarm signal when the control signal is not sensed by the diode.

4. A method for detecting removal of an electronic device, comprising:
providing an arrangement in operative engagement with a power source and an electronic device,
the arrangement sending control signal via a first conducting element to the electronic device,
the control signal returning to the arrangement via a second conducting element that is electrically connected to the arrangement, and
the arrangement triggering an alarm signal to an alarm when the control signal is not returned from the electronic device in the second conducting element.

5. The method according to claim 4 wherein the method further comprises activating a diode electrically connected to the second conducting element when the alarm has been activated.

6. The method according to claim 4 wherein the method further comprises triggering the alarm signal when the first conducting element has been disconnected.

7. The method according to claim 4 wherein the method further comprises triggering the alarm signal when the second conducting element has been disconnected.

8. The method according to claim 4 wherein the method further comprises triggering the alarm signal when the power source has been disconnected from the arrangement.

9. The method according to claim 5 wherein the method further comprises triggering the alarm signal when a resistance from the diode is not sensed.

10. The method according to claim 5 wherein the method further comprises determining a location of a disconnection of the first conducting element.
